(19) United States
(12) Patent Application Publication
(10) Pub. No.: US 2014/0188509 A1
(43) Pub. Date: Jul. 3, 2014

(54) SYSTEMS AND METHODS OF SERVICE PROVIDER IDENTIFICATION IN A COMPUTER NETWORK ENVIRONMENT

(71) Applicant: PAR8O, INC., Cambridge, MA (US)

(72) Inventors: Daniel Palestrant, Newton, MA (US); Adam Sharp, Indianapolis, IN (US)

(73) Assignee: PAR8O, INC., Cambridge, MA (US)

(21) Appl. No.: 13/733,711

(22) Filed: Jan. 3, 2013

(51) Int. Cl. G06F 19/00

(52) U.S. Cl. CPC G06F 19/322
USPC 705/3

(57) ABSTRACT

Systems and methods of providing information via a communications network are provided. A data processing system can obtain referral input data including at least one of subject condition data and remittance data, and can identify, from a database, service provider data associated with a service provider and based on the referral input data. At least one of the referral input data and the service provider data can be provided for display by a referring computing device associated with the data processing system, and a referral request can be sent via the communications network to a recipient computing device associated with the service provider. The referral request can include at least a portion of the referral input data. Responsive to the referral request, availability data of the service provider can be obtained based on at least one of the subject condition data and the remittance data.

### BACKGROUND

Service providers provide a good or service to a customer. A service provider may be unable or unwilling to offer a particular good or service to a customer. In such a case, the customer may utilize a different service provider to accommodate the customer's needs.

### SUMMARY

At least one aspect is directed to a computer implemented method of providing information via a communications network. The method can obtain, by a data processing system, referral input data. The referral input data can include at least one of subject condition data and remittance data. The method can also identify, from a database, service provider data associated with a service provider, based on the referral input data. The method can provide at least one of the referral input data and the service provider data for display by a referring computing device associated with the data processing system, and can send a referral request via the communications network to a recipient computing device associated with the service provider. The referral request can include at least a portion of the referral input data. The method can also obtain, responsive to the referral request, availability data of the service provider based on at least one of the subject condition data and the remittance data.

At least one aspect is directed to a system of providing information via a communications network. The system includes a data processing system having at least one of a referral network engine and a database. The data processing system can obtain referral input data that includes at least one of subject condition data and remittance data. The data processing system can identify, based on the referral input data, service provider data associated with a service provider. The data processing system can also provide at least one of the referral input data and the service provider data for display by a referring computing device associated with the data processing system, and the data processing system can send a referral request via the communications network to a recipient computing device associated with the service provider. The referral request can include at least a portion of the referral input data. The data processing system can also obtain, responsive to the referral request, availability data of the service provider based on at least one of the subject condition data and the remittance data.

At least one aspect is directed to a computer readable storage medium having instructions to provide information on a communications network. The instructions can include instructions to obtain referral input data. The referral input data can include at least one of subject condition data and remittance data. The instructions can also include instructions to identify service provider data associated with a service provider based on the referral input data, and instructions to provide at least one of the referral input data and the service provider data for display by a referring computing device associated with the data processing system. The instructions can include instructions to send a referral request to a recipient computing device associated with the service provider. The referral request can include at least a portion of the referral input data. The instructions can also include instructions to obtain, responsive to the referral request, availability data of the service provider based on at least one of the subject condition data and the remittance data.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a block diagram depicting one example of a system for providing information via a communications network, according to an illustrative implementation;

FIG. 2 is a display depicting an example environment of a subject referral network according to an illustrative implementation;

FIG. 2A is a display depicting an example environment of a subject referral network according to an illustrative implementation;

FIG. 3 is a display depicting an example environment of a subject referral network according to an illustrative implementation;

FIG. 3A is a display depicting an example environment of a subject referral network according to an illustrative implementation;

FIG. 4 is a display depicting an example environment of a subject referral network according to an illustrative implementation;

FIG. 4A is a display depicting an example environment of a subject referral network according to an illustrative implementation;

FIG. 5 is a display depicting an example environment of a subject referral network according to an illustrative implementation;

FIG. 5A is a display depicting an example environment of a subject referral network according to an illustrative implementation;

FIG. 6 is a display depicting an example environment of a subject referral network according to an illustrative implementation;

FIG. 6A is a display depicting an example environment of a subject referral network according to an illustrative implementation;

FIG. 7 is a flow chart depicting a method of providing information via a communications network, according to an illustrative implementation;

FIG. 8 is a flow chart depicting a method of providing information via a communications network, according to an illustrative implementation; and

FIG. 9 is a block diagram illustrating a general architecture for a computer system that may be employed to implement various elements of the systems and methods described and illustrated herein, according to an illustrative implementation.

### DETAILED DESCRIPTION

Following below are more detailed descriptions of various concepts related to, and implementations of, methods, apparatuses, and systems for providing information via a communications network. The various concepts introduced above and discussed in greater detail below may be implemented in any of numerous ways, as the described concepts are not limited to any particular manner of implementation. Examples of specific implementations and applications are provided primarily for illustrative purposes.

In a computer networked environment, a referral network engine can identify potential recipients of a referral, and can provide referral requests on behalf of a service provider. Recipients of the referral request can respond by indicating availability to receive the referral. For example, in a health care environment a patient may be visiting a primary care physician as part of an annual physical examination. During this examination, the physician can determine that the patient should see a second physician (e.g., a physician with a particular specialization) for further examination. In this example, a data processing system can obtain, from the primary care physician or the patient, data about the patient. From this data, a referral network engine of the data processing system can identify physicians having the particular specialization identified by the primary care physician as candidates qualified to receive the referral.

Continuing with this example, the data processing system can provide a referral request to the specialized physicians. The specialized physicians, e.g., the recipients of the referral request in this example, can accept the referral request by indicating to the referring physician via the data processing system their availability or willingness to see the patient. The patient and the specialized physician can then make an appointment for further examination.

Thus, in some implementations, the data processing system can receive referral input data associated with a subject such as a patient. Using this referral data, the data processing system can identify service providers (e.g., specialized physicians) as candidates to receive a referral request. The data processing system can send referral requests to one or more service providers. Service providers available or amenable to offering a good or service to the subject can indicate their availability to the subject (or to another service provider on behalf of the subject) via the data processing system.

The data processing system can also administer a referral network. For example, a referral network engine of the data processing system can communicate with at least one database to obtain, access, and maintain data about service providers who are members of the referral network, as well as service providers who are not members of the referral network. To make a referral, the referral network engine can acquire data about the subject being referred. Based at least in part on this data, the referral network engine can identify service providers that can receive the referral request. The referral request can be communicated to service providers via the referral network, e.g., via an email or referral network account activity; or through an external communication channel such as a facsimile machine. To accept the referral request, for example, the recipient service provider can logon to the referral network to send a communication indicating their acceptance. Recipient service providers who are not members of the referral network can join the referral network in order to accept a referral request.

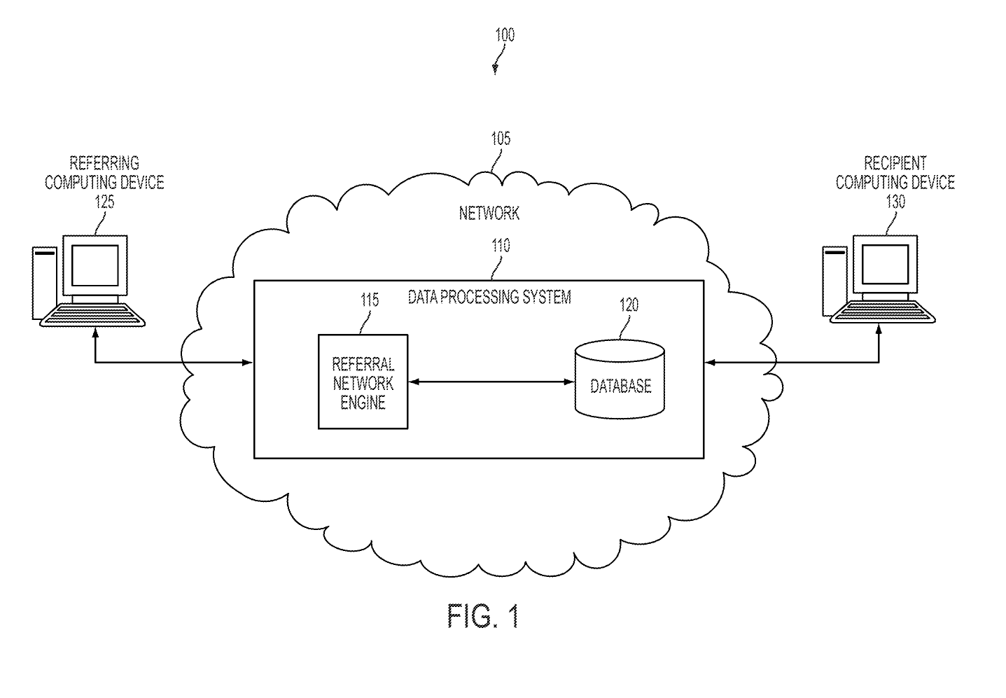

FIG. 1 illustrates an example system 100 for providing information via a communications network, such as at least one network 105. The network 105 can include computer networks such as the internet, local, wide, metro or other area networks, intranets, satellite networks, and other computer networks such as voice or data mobile or landline phone communication networks. In one implementation, the network 105 includes a communications network configured to send and receive facsimile communications.

The system 100 can also include at least one data processing system 110. The data processing system 110 can include at least one server. For example, the data processing system 110 can include a plurality of servers located in at least one data center or server farm. In one implementation, the data processing system 110 includes at least one referral network engine 115. The data processing system 110 can also include at least one database 120. The referral network engine 115 can include at least one processing unit or other logic device such as programmable logic arrays configured to communicate with the database 120 and with other computing devices via the network 105. The referral network engine 115 can be a separate component, a single component, or part of the data processing system 110. In one implementation, the referral network engine 115 is part of at least one server. The data processing system 110 can include at least one logic device such as a processor to communicate via the network 105, for example with the referral network engine 115 or the database 120.

The data processing system 110 and its components (e.g., the referral network engine 115) can communicate via the network 105 with computing devices such as at least one referring computing device 125 and at least one recipient computing device 130, such as desktop computers, laptop computers, tablet computers, smart phones, personal digital assistants, mobile or landline phones, or facsimile machines for example. In some implementations, the data processing system 110 administers the referral network.

The referring computing device 125 can be associated with a referring service provider, such as a health care provider. For example, the referring computing device 125 can be located in a hospital, doctor's office, health clinic, subject or patient's home or office, a health care provider facility, or a health maintenance organization facility. In one implementation, the data processing system 110 obtains referral input data. For example, a health care provider can enter referral data about a subject into an interface of the referring computing device 125. The referral input data can include data about the condition of the subject (e.g., a diagnosis), administrative data about the subject (e.g., name, address, age, or gender) or the subject's medical history or records.

The referral input data can also include remittance data, such as insurance data or other information that indicates how the subject will pay for the good or service. For example, the remittance data can indicate the subject's health care plan, health insurance, health care provider, health maintenance organization, or the type of health care coverage that the subject has. The remittance data can also indicate that the subject has no health care coverage, and will self pay. In some implementations, the remittance data indicates credit card, debit card, or banking information. The remittance data can also indicate more generally other forms of insurance, such as dental insurance or life insurance, or forms of insurance generally outside the health care environment, such as homeowner insurance.

In one implementation, the data processing system 110 provides a user interface for display at the referring computing device 125, as discussed herein, to prompt the service provider, their assistant, the subject or other delegate to enter referral input data. For example, the referring computing device 125 can access the data processing system 110 (e.g., a host server) to display a web page or other display, document, or information resource, at the referring computing device 125 via the network 105. The web page can be a web page of a referral network website. The web page can include at least one window, drop down menu, listing, or other graphical user interface component to receive the referral input data. The referral input data can be stored in the database 120, and can be provided for display (e.g., on a web page) at the referring computing device 125.

In one implementation, based at least in part on the referral input data, the data processing system 110 identifies service provider data associated with at least one service provider. For example, the referral network engine 115 can process the referral input data and use this data to identify at least one suitable service provider. The service provider data that identifies service providers can be stored in the database 120, where it can be retrieved by the data processing system and provided for display at the referring computing device 125.

The service provider data can be obtained from service providers or their delegates, or from publically available sources such as professional organizations, governmental licensing agencies, publically available registries, licensing boards, administrative agencies, or other publically available information and stored in the database 120. For example, service provider data can include identifying information of health care providers, such as the publically available location of their office or the nature of the services offered by a health care provider, such as podiatry or dermatology. The service provider data can also be obtained by the database 120 via the data processing system directly from the recipient computing device 130. For example, a health care provider can be a member of a referral network associated with the data processing system 110. In this example, the health care provider can enter service provider data (e.g., profile information) into the database 120 associated with the referral network.

Referring again to a health care environment example, a subject visiting a first health care provider may wish to consider a referral to a second health care provider. The referral input data entered into the referring computing device 125 by or on behalf of the first health care provider can indicate the subject's name, the subject's condition (e.g., a reason for referral such as a foot injury), and remittance data (e.g., a type of health insurance coverage). The data processing system 110 can match the referral input data with service provider data to identify one or more potential second health care providers suitable to receive a referral regarding the subject. For example, the second health care providers can be specialists in the subject's condition, such as a podiatrist specializing in foot injuries.

The data processing system 110 can provide the service provider data for display at the referring computing device 125 e.g., on a web page. For example, the referring computing device 125 can obtain the referral input data via a graphical user interface. The health care provider (or delegate thereof) can enter this information by clicking or touching a link or button on the display, or by entering another input, e.g., via a keyboard or voice command. The referral network engine 115 can process the referral information and identify (e.g., from the database 120) service providers as candidates to receive the referral. Service provider data, such as the name, address, specialty, type of good or service offered, geographic location, and availability data can be provided for display at the referring computing device 125. For example, the data processing system 110 can provide a web page for display at the referring computing device 125, via the network 105, that displays service provider data indicating one or more service providers as candidates to receive the referral. The service provider data can include a list of health care providers in a window or hierarchical display box of a web page. In one implementation, one web page (or other document) concurrently displays the referral input data and the service provider data.

In some implementations, the data processing system 110 sends a referral request to at least one recipient computing device 130. For example, the data processing system 110 can provide service provider data for display at the referring computing device 125, e.g., in a first health care provider's office or examination room. The first health care provider such as a physician can view the service provider data and interface with the referring computing device 125 to select one or more second health care providers (e.g., a specialized health care provider) to whom the first health care provider wishes to make a referral. The data processing system 110 can obtain an indication of this selection and provide the referral request as a notification to a recipient computing device 130 associated with the second health care provider (or other service provider) via the network 105. For example, the referral request can be provided via email or facsimile transmission. In one implementation, the health care provider making the referral (e.g., from the referring computing device 125) and the health care provider receiving the referral (e.g., at the recipient computing device 130) are members of a referral network, and the request for the referral can be provided via the referral network, for example as an electronic communication that the health care provider receiving the referral receives by accessing, logging onto, or joining the referral network.

In some implementations, the referral request alerts at least one service provider of the opportunity to provide a good or service to a subject. For example, the referral request sent to a health care or other service provider at the recipient computing device 130 can include at least a portion of the referral input data, such as the subject condition data (e.g., the reason for the referral) or the remittance data. In one implementation, medical records of the subject or other information such as the name of the subject are absent from the referral request.

Responsive to a referral request, the data processing system 110 can obtain availability data of at least one service provider. For example, a referral request can be displayed to a health care provider at the recipient computing device 130. This health care provider may be interested in accepting the referral, for example by examining the subject (e.g., patient) or offering another service to the subject. The health care provider or their delegate receiving the referral request can interface with a display of the recipient computing device 130 to accept the referral. For example, based on an a review of the subject condition data or the remittance data, a health care provider can click a button or link to indicate that they are available to take the referral and see the patient. In one implementation, the referral request includes a referral code, and the health care provider can enter the referral code into an interface of the referral network to view or accept the referral request. The recipient computing device 130 can communicate the acceptance of the referral (e.g., availability data) to the data processing system 110 or to the referring computing device 125 via the network 105 for display at the referring computing device 125. The availability data can be communicated via email, telephone, or facsimile transmission. In one implementation, the availability data is communicated via a referral network where at least one of the health care provider making the referral and the health care provider accepting the referral are members of the referral network.

In some implementations, the service provider data indicates remittance data accepted by the service provider. For example, a doctor or other health care provider who is a potential recipient of a referral request can indicate to the data processing system 110 what insurance plans they accept. This indication can be stored in the database 120. A logic device of the data processing system 110 such as the referral network engine 115 can determine that the referral input data includes the health insurance plan accepted by the health care provider. In this example, based at least in part on the match between the referral input data (e.g., indicating that the patient has a particular health insurance plan) and the indication of remittance data provided by the health care provider receiving the referral (e.g., indicating that the health care provider accepts that particular health insurance plan), the data processing system can identify the health care provider as a candidate to receive a referral request, or can send the referral request to that health care provider.

In one implementation, the data processing system 110 can obtain, from the recipient health care provider (e.g., the health care provider who receives referral requests), and indication of preferred remittance data. For example, the recipient health care provider can provide service provider data indicating that the recipient health care provider accepts multiple different forms of payment (e.g., self pay, or a number of different health care insurance plans). In this example, the recipient health care provider can indicate at least one preferred insurance plan or other preferred remittance data such uninsured self payment options. The data processing system 110 can access this information from the database 120 and determine that a subject seeking a referral (e.g., a patient visiting a primary care physician) has remittance data (e.g., a type of health insurance) that matches the preferred remittance data indicated by the recipient health care provider. The data processing system 110 can send (or instruct that the referring computer device 125 send) the referral request to the recipient computing device 130 associated with the recipient service provider via the network 105. The referral request can indicate that the subject is associated with the preferred health insurance coverage or other preferred remittance data. The recipient computing device 130 can communicate with the referring computing device 125 to indicate that the recipient service provider is available to take the referral.

In addition or as an alternative to including preferred remittance data, in some implementations the service provider data includes at least one availability time period indicating a general time period within which the recipient service provider is available to see the patient or other subject being referred. For example, the recipient service provider can indicate one availability time period to see patients having remittance data (e.g., uninsured patients who self-pay for medical treatment) within a first time period and can indicate another availability time period to see patients having different remittance data (e.g., a type of health insurance). These availability time periods, which can be different from each other, can be obtained by the database 120 and stored as service provider data. For example the recipient service provider can indicate an availability time period of 2 days from acceptance of a referral to examine or treat a subject having self pay remittance data, or a first subject condition (e.g., an illness or medical condition), and can indicate an availability time period of 10 days from acceptance of a referral to examine or treat a subject having a particular brand, form, or type of health insurance, or a second subject condition such as a different illness or medical condition.

In one implementation, the recipient service provider indicates availability data that includes a time period, and provides service provider data to the data processing system 110 to adjust or time shift the time period when at least one criterion is satisfied. For example, a recipient service provider can indicate availability to see patients referred to the recipient service provider via the data processing system 110 within a time period of two to four weeks from acceptance of a referral request. The recipient service provider can also provide service provider data to the data processing system 110 to time shift this two to four week availability time period forward or backward in time. For example, when the referral input data includes remittance data preferred by the recipient service provider, the service provider data can time shift the availability time period forward in time by one week, (e.g., within one to three weeks from acceptance of the referral in this example). In another example, referral input data having disfavored remittance data (e.g., a particular health insurance plan) can time shift the availability time period backward by one week (e.g., so the recipient service provider indicates an availability time period of three to five weeks to see the patient in this example).

In some implementations the service provider data can also include instructions to time shift or adjust the availability time period based on preferred (or disfavored) subject condition data (e.g., a medical reason for a referral) included in the request. For example, a dermatologist interested in a particular skin condition can expedite an availability time period to see a patient being referred for that skin condition. In another implementation, the referring computing device 125 can display (e.g., on a web page) availability data of the recipient service provider that is adjusted based on a cost of services offered by the recipient service provider. For example, a subject willing to pay more to see the service provider can receive a more favorable (e.g., earlier) availability time period than a subject unwilling to pay an additional fee.

The recipient service provider who receives a referral request at the recipient computing device 130 can accept the referral by entering data indicating their availability into the recipient computing device 130. This availability data can be displayed at the referring computing device 125 to the referring service provider or to the subject (e.g., the patient). For example, the recipient service provider can indicate that they are generally available to examine the subject during a time period such as within the next day, three days, week, or other time period. In one implementation, the availability data can be displayed on a web page rendered at the referring computing device 125.

The availability data can also indicate a time period of recipient service provider availability. The time period can be a general block, such as a four or eight hour time period of a day, or a multi day time period. The availability time period can also be cyclical, e.g., between 10:00 am and 2:00 pm on Mondays, Wednesday, and Fridays. In some implementations, the availability time period is not a defined appointment time period. For example, the availability data can indicate that the recipient service provider is available to see a subject at some time within the next two weeks. The recipient service provider and the subject (or the subject's referring service provider) may then make an appointment within that two week availability time period window. In another example, the availability data includes a time period of at least eight hours, indicating for example that the recipient service provider is available to receive a referral during working hours of one day. In this example, the subject and the recipient service provider may schedule an appointment within the eight hour availability time period, where the appointment is for 30 minutes or one hour, or another time period that is less than the eight hour availability time period.

Thus, the referring computing device 125 can display the availability data indicating a general availability time period where the recipient service provider may be available to schedule appointments, with the recipient service provider being unavailable for at least a portion of the availability time period. For example, the availability time period may indicate that the recipient service provider is available to receive the subject during the next 72 hours from acceptance of the referral. In this example, the recipient service provider indicates a willingness to make an appointment sometime within the next 72 hours during an appointment time period at a time when the recipient service provider is available, as the recipient service provider is not available for an appointment during the entire 72 hour time period in this example.

In some implementations, based on referral input date from a subject, the referral network engine 115 identifies a plurality of service providers. The group of service providers in this example has service provider data indicating that they are suitable referrals for the subject. For example, the service provider data can indicate that the service providers have qualifications corresponding to the subject condition data, or that the service providers accept insurance coverage identified in the remittance data. The plurality of service providers can be displayed in a list on a web page that the data processing system 110 provides for display at the referring computing device 125, responsive to input of the referral input data. The data processing system 110 can rank or list the plurality of service providers in an order for display on the web page. For example, the service providers can be identified by name, address, the nature of the services offered, the number of past referrals received or accepted, remittance data accepted or not accepted by the service providers, preferred remittance data, availability data, or geographic location data. In one example, the data processing system 110 displays service provider data of service providers that satisfy referral input data and located within a radius of the referring computing device, such as within 75 miles.

In some implementations, the data processing system 110 orders the service providers based at least in part on membership in a referral network. For example, the data processing system 110 can administer a service provider referral network that identifies service providers that can receive referrals from other service providers. The referring computing device 125 can be associated with a referring service provider that is a member of the referral network. The referring service provider or their delegate enters referral input data of a subject in need of a referral into the referral network. The data processing system 110 in this example can identify other (e.g., recipient) service providers who are members of the referral network and satisfy the referral input data, as well as service providers who are not members of the network but nevertheless still satisfy the referral input data. In this example, members of the referral network may be ordered higher or more prominently displayed on a web page rendered at the referring computing device 125.

For example, the database 120 can store service provider data of service providers who are members of the referral network, as well as service providers who are not members of the referral network. In one implementation, responsive to referral input data, the referral network engine 115 can identify a service provider who is absent from the group of service providers having data that is stored in the database 120. For example, the referral network engine 115 can obtain service provider data from a source external to the data processing system 110, such as a public directory of service providers. The data processing system 110 can provide service provider data from the absent service provider for display at the referring computing device 125. In this example, the referring service provider or the subject can view information about the service providers who do not have service provider data stored in the database 120.

In one implementation where the data processing system 110 administers a referral network, the referral network engine 115 can identify service provider data of a service provider that is a member of the referral network. For example, this service provider may have an online account (e.g., free or subscription based) to maintain membership in the referral network. The service provider data can be stored in the database 120. The data processing system 110 can identify the service provider as being a candidate for referral based on the referral input data and the service provider data. The data processing system 110 can send the referral request to the recipient computing device 130 associated with the service provider via the referral network. For example, the service provider can log onto the referral network to view the referral request, or the service provider can receive an email or other electronic communication indicating that a referral request awaits the service provider on the referral network. The service provider can then access the referral network to view the referral request. The service provider can accept the referral request via the referral network by clicking a button or other graphical user interface on a web page display at the recipient computing device 130, for example.

In some implementations, the data processing system 110 determines that the service provider is not a member of the referral network. For example, the data processing system 110 can determine that a recipient service provider whose service provider data satisfies the referral input data does not have an account with the referral network. In this example, the data processing system 110 can provide instructions to notify the recipient service provider of the referral request via a facsimile transmission. The facsimile transmission can indicate an interest in referring a subject to the recipient service provider. The facsimile can also include instructions or a request for the recipient service provider to join the referral network. In some implementations, the facsimile referral request indicates at least a portion of the referral input data, such as a subject condition or remittance data. In one implementation, the subject's name is absent from the facsimile referral request. In some implementations, the recipient service provider joins the referral network and is granted permission to accept the referral request subsequent to joining the referral network.

Acceptance of the referral request (by members or non-members of the referral network) can be obtained by the data processing system and indicated in a web page or other information resource or document display at the referring computing device 125 as well as the recipient computing device 130.

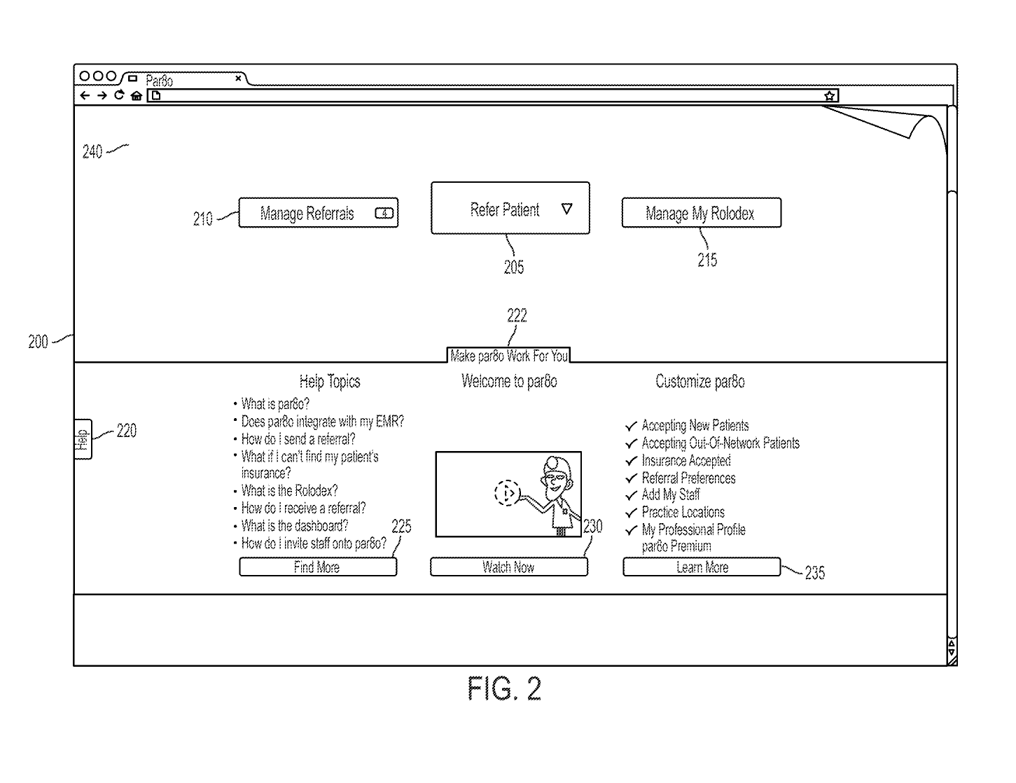

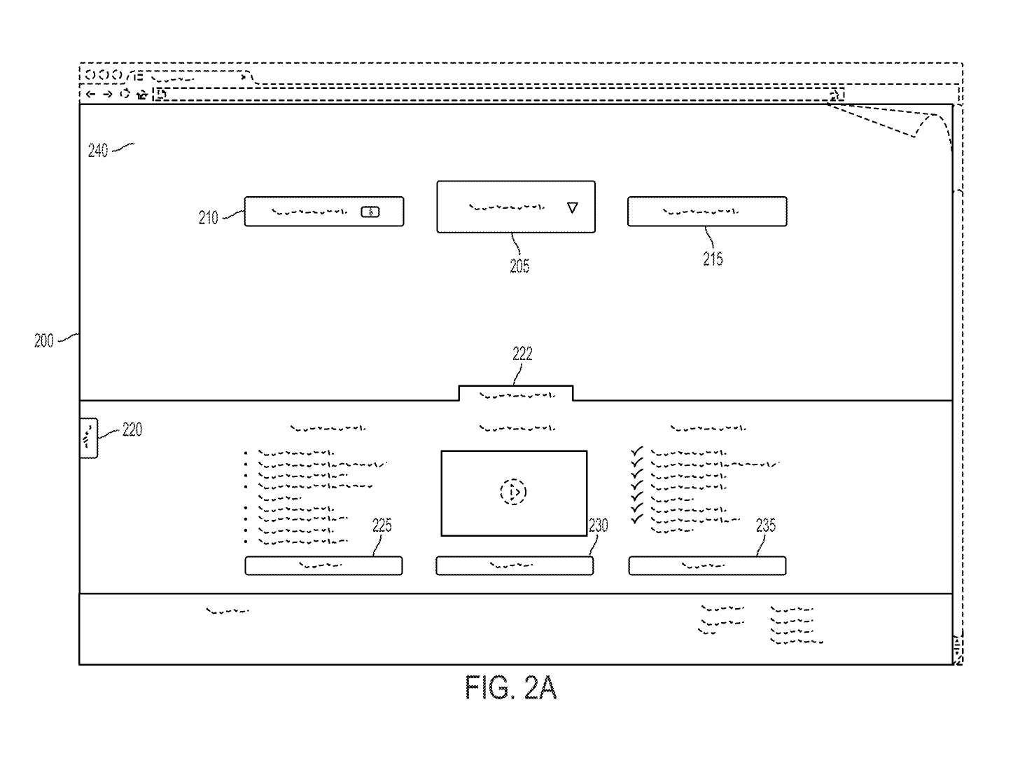

FIG. 2 and FIG. 2A depict an example environment for obtaining referral data according to an illustrative implementation. In some implementations, the home page display 200 of FIG. 2 and FIG. 2A is a web page (or other network document or information resource) display of a referral network website. The referring computing device 125 or the recipient computing device 130 can access the data processing system 110 via the network 105 to request access to a web page of the referral network website. The web page, e.g., the home page display 200, can be rendered at the referring computing device 125 or at the recipient computing device 130.

The home page display 200 can be presented to a service provider or a subject via a display (e.g. monitor) of the referring computing device 125. For example, the referring service provider (e.g., the service provider giving the referral) may logon to or otherwise access a referral network controlled by the data processing system 110. The home page display 200 can provide information about the referral network or the process of identifying at least one candidate recipient service provider (e.g., the service provider receiving the referral). The home page display 200 can also be presented to recipient service providers at the recipient computing device 130. For example, a service provider can access the referral network at the recipient computing device 130 to receive a referral request, accept a referral request, indicate availability data to the referring service provider, to join the referral network, or to add profile information to the referral network for example.

The home page display 200 can include at least one refer patient button 205, at least one referral management button 210, and at least one rolodex management button 215. In one implementation, the refer patient button 205 is approximately centered near the top of the home page display 200, as in the example of FIG. 2 and FIG. 2A, with the manage referrals button 210 and the rolodex management button 215 disposed on opposite sides of the refer patient button 205 and in horizontal (or longitudinal) axial alignment with the refer patient button 205. The buttons 205, 210, and 215 can be rectangular, or other shapes such as square, oval, elliptical, circular, or other polygonal shapes. In one implementation, the refer patient button 205 is in a rectangular shape of substantially equal length (e.g., +/−10%) and of substantially twice the width (e.g., +/−10%) as the length and width of the manage referrals button 210 and the rolodex management button 215. In some implementations, rather than buttons, the home page display 200 can include other interfaces such as links to interface with a service provider, their delegate, or a subject.

The refer patient button 205 can be accessed, e.g., at the referring computing device 125 by a referring service provider or their delegate to obtain a referral for the subject. For example by clicking the refer patient button 205, the referring service provider can access an interface to provide information about the subject. This information can include subject condition data, remittance data, the subject name or other administrative information, or other referral input data. The referral patient button 205, when actuated, can provide a second web page, text window, drop down menu, or other information resource or display to receive this information. The manage referrals button 210, when accessed, can cause the referral network to provide a display (e.g., as a web page) of outstanding referrals made or received by a service provider. This display can also indicate the status of the referral, such as pending, completed, accepted, or declined for example. The refer patient button 205 can be clicked e.g., at the referring computing device 125 as part of a process to obtain a referral for subjects other than patients, such as clients of a service provider.

In one implementation, the manage referrals button 210 can be used to change the status of a referral. For example, the referring service provider at the referring computing device can click the manage referrals button 210 to access a web page (e.g., hosted by the referral network engine 115) and indicating referrals made by the referring service provider. The referring service provider may view referral requests, and can cancel or withdraw a referral request, for example. The rolodex management button 215, when clicked, can provide a web page or other display of one or more members of the referral network, other service providers who are not members of the referral network, or contacts of the service provider who may or may not be members of the referral network.

In one implementation, the home page display 200 of the referral network includes a help tab 220. The help tab 220 or a work for you tab 222 in the example of FIG. 2 and FIG. 2A can include help topic information, such as frequently asked questions about the nature of the referral network. For example, a find more button 225 can be clicked to display a list of frequently asked questions and their answers. The help tab 220 can also include a welcome to the referral network video presentation. For example, a service provider can clock a watch now button 230 to view a video about the referral network that can be embedded in the home page display 200.

The help tab 220 can also include customization information to allow service providers to customize their referral network profile, accept patients (or other subjects), enter preferred referral input data such as preferred remittance data or location data, add delegates (e.g., assistants, nurses, or staff) who can access the referral network on behalf of a service provider and receive or make referrals, or access a preferred or exclusive portion of the referral network such as web pages or information available upon payment of a subscription or membership fee to join or remain in the referral network. In one implementations, the service provider or other user can click a learn more tab 235 to access information regarding the customization of the home page display 200 (e.g., a home web page) or a service provider's referral network account or profile.

In one implementation, the home page display 200 includes at least one button display area 240 that includes interfaces to refer subjects, manage referrals, and manage contact information. For example, the button display area 240 can include the refer patient button 205, the manage referrals button 210, and the rolodex management 215 set against a monochromatic background. In some implementations, the button display area 240 consists of three operational interfaces to access information or displays, e.g., the refer patient button 205, the manage referrals button 210, and the rolodex management button 215. The button display area 240 can be void of additional user interfaces. In various implementations, the button display area 240 can consist of one, two, three, or more operational interfaces such as any one or more of the refer patient button 205, the manage referrals button 210, and the rolodex management button 215. The button display area 240 can be defined by a uniform or monochromatic background color or marked boundary, with buttons 205, 210, or 215 disposed within the button display area 240. In this example, the buttons 205, 210, or 215 can include colors (e.g., dark blue or orange) different than the background color of the button display area 240 (e.g., light blue). In some implementations, the button display area 240 is an area occupying substantially (e.g., +/−10%) the top horizontal half of the home page display 200.

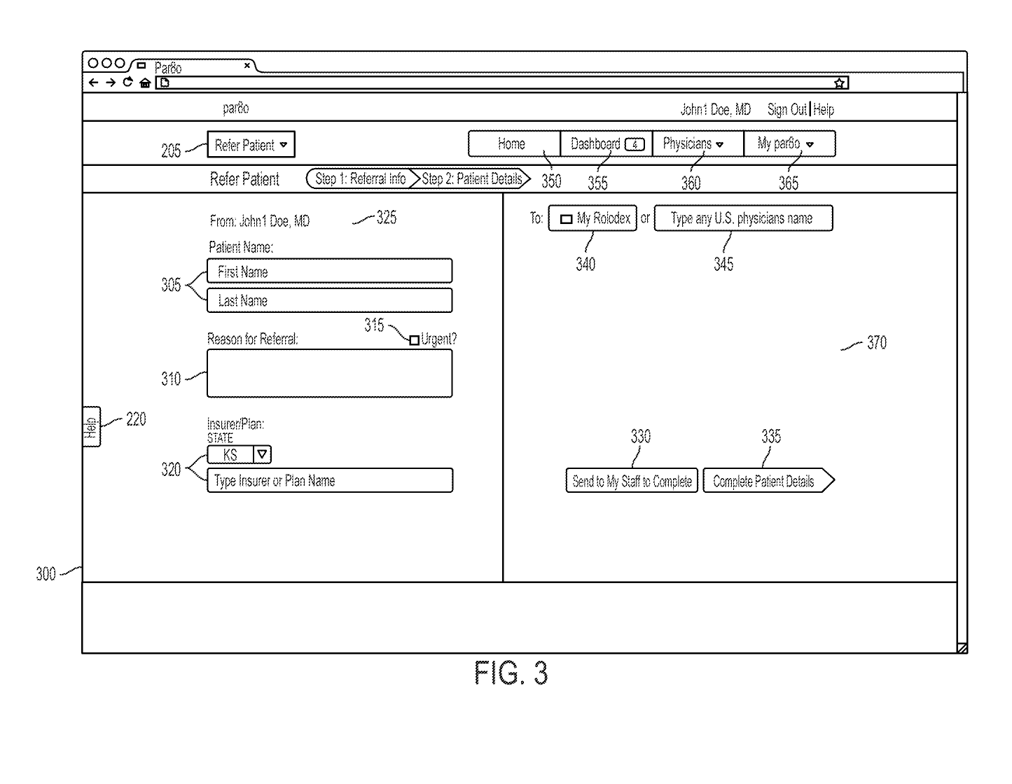

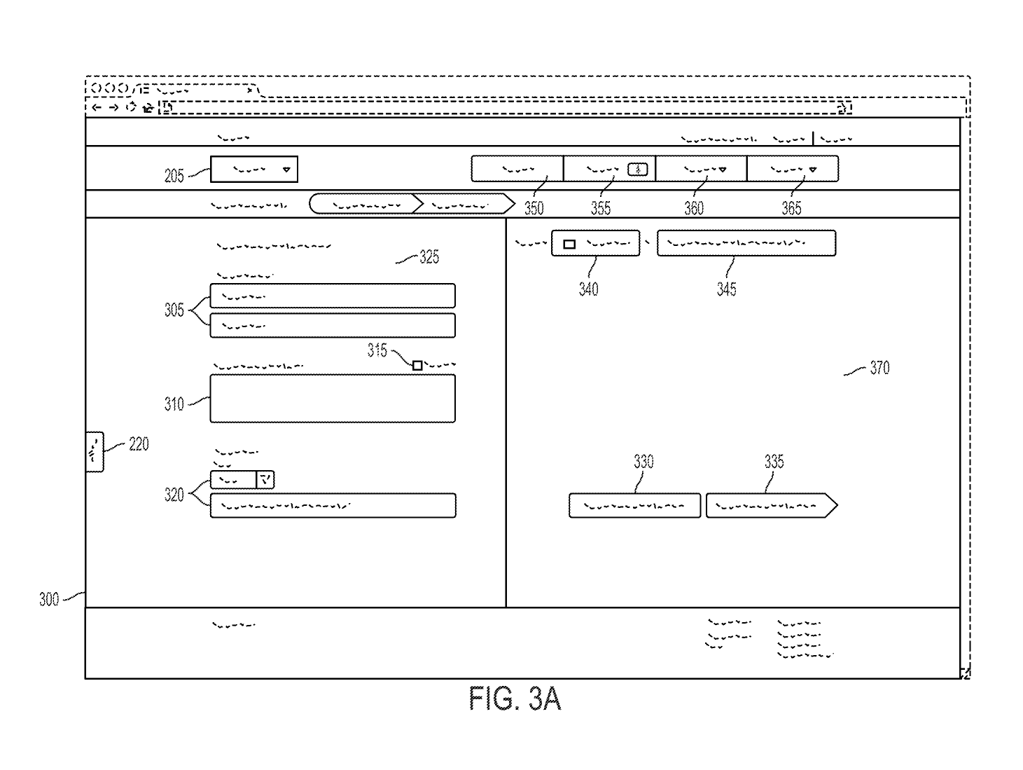

The home web page or other home page display 200 can be displayed on any computing device (e.g., laptop, desktop, tablet, or smartphone) such as the referring computing device 125 or the recipient computing device 130. A service provider (or their delegate) providing or receiving a referral can interface with the home page display 200. For example, with reference to FIGS. 2 and 3, a service provider can click the refer patient button 205 to cause the data processing system 110 to provide the referral display 300 for display at a computing device. The referral display 300 can include a web page, popup window, or other online document or information resource provided by the data processing system 110 (e.g., via the database 120) for display at the referring computing device 125 or the recipient computing device 130. The referral display 300 can include at least one interface to obtain referral input data such as subject condition data, remittance data or other information about the subject such as the name of a patient seeking a referral.

In one implementation, the referral display 300 includes at least one subject (e.g., a patient) name interface 305. The name interface 305 can include a window or slot in the referral display 300 configured to receive or produce text. For example, the referral display 300 can include a first name interface 305 for entry of the subject's first name, and a second name interface 305 for entry of the subject's last name.

The referral display 300 can also include at least one subject condition interface 310 having at least one window or slot configured to receive or produce text regarding the reason for the referral. For example, the referring computing device 125 can display the referral display 300 to the referring service provider, who enters at least one reason for referring the subject into the subject condition interface 310. The reasons for referral can include a medical condition or diagnosis, (e.g., a heart condition, shortness of breath, blurred vision), or indication of what type of specialist service provider could be of assistance to the subject (e.g., cardiologist requested). For example, the subject condition interface 310 can include a drop down window to select subject condition data from a list of reasons for referral, or a text entry box for the referring service provider or delegate thereof to enter (e.g., type) reasons for referral into the subject condition interface 310. In some implementations, the referral display 300 includes at least one urgency interface 315 such as a checkbox for the referring service provider to check, indicating that the subject is in need of an urgent or expedited referral (e.g., within 48 hours or 24 hours).

The referral display 300 can also include at least one remittance data interface 320. The remittance data interface 320 can include at least one drop down menu, text box, or window to receive payment information data for the service offered by the recipient service provider. In one implementation, the remittance data interface includes a data entry space to indicate a type of insurance coverage, such as a health insurance plan. For example, the referral display 300 can include a first remittance data interface 320 for entry of a state (or other geographic region) where the subject is located or has insurance coverage, and a second remittance data interface 320 for entry of insurance information such as a name of a health care insurance provider or an insurance carrier or plan name. In some implementations, a single remittance data interface 320 can obtain the state and the insurance plan name (or other remittance data). In one implementation, a first remittance data interface 320 can be clicked on to display a list of geographic regions such as states of the United States. In this example, the referring service provider can select one of the states, and also enter an insurer or insurance plan name into a second remittance data interface 320. This data can be provided for example in a web page or popup window.

In some implementations, the referral display 300 includes the help tab 220. When clicked, the help tab 220 can provide frequently asked questions and their answers, or can provide tutorials or sample data entries into the name interface 305, the subject condition interface 310, or the remittance data interface 320.

In some implementations, the referral display 300 includes at least one referral input data area 325. For example, the referral input data area 325 can occupy the majority of one half of the referral display 300, such as the left side as depicted in FIG. 3 and FIG. 3A, where the tab 220 is external to the referral input data area 325 in this example. One or more input interfaces can be present in the referral input data area 325 to receive data. For example, the referral input data area 325 can include at least one name interface 305, at least one subject condition interface 310, at least one urgency interface 315, and at least one remittance data interface 320. In some implementations, the referral input data area 325 consists of at least one name interface 305, one subject condition interface 310, one urgency interface 315, and at least one remittance data interface 320. The referral input data area 325 can be void of additional input interfaces. In various implementations, the referral input data area 325 can consist of one, two, three, or more input interfaces configured to receive different forms of input, such as a subject's name, subject condition data, or subject referral data, for example. The referral input data area 325 can be defined by a uniform or monochromatic background color or marked boundary, with the interfaces 305, 310, 315, or 320 disposed within the referral input data area 325. In this example, the interfaces 305, 310, 315, or 320 can include colors different than the background color of the referral input data area 325.

The referral input data area 325 can indicate the name of the referring service provider, e.g., indicating that the referral is from or on behalf of “John1 Doe, MD” in the example of FIG. 3 and FIG. 3A. In one implementation, the referral is from a referring service provider who is a member of the referral network operated by the data processing system 110.

Interfaces such as the name interface 305, the subject condition interface 310, the urgency interface 315, and the remittance data interface 320 can be populated using voice activation or recognition. For example, responsive to a prompt, the referring service provider can speak into a microphone to populate the interfaces 305, 310, 315, or 320 with referral input data.

The referral display 300 can include at least one delegate to staff button 330. This delegate button 330 (or link) when clicked can alert a delegate of the referring service provider of a need to complete a referral request using the referral display 300. For example, a referring service provider at the referring computer device 125 can click the delegate button 330. Responsive to the click, the data processing system 110 can notify the delegate via the network 105 (e.g., via email or voicemail) to logon to the service provider's referral network account and complete a request for a referral, for example by entering data into an interface of the referral input data area 325.

The referral display 300 can include at least one patient details button 335. In one implementation, responsive to a click or activation of the patient details button 335, the data processing system 110 provides a web page or other display (e.g., pop up window) of detailed subject information, or of one or more interfaces to receive this information. The detailed subject information can include medical records or administrative information, (e.g., age, contact information, address, phone number or email address) of the subject, for example. This detailed information as well as data obtained via the referral input data area 325 of the referral display 300 can be stored in the database 120 and accessed by the data processing system 110 for display by the referring computing device 125 or the recipient computing device 130.

The referral display 300 can include at least one add to contacts button or link, such as at least one my rolodex button 340. In one implementation, the referral service provider has an account with the referral network administered by the data processing system 110, and the my rolodex button 340 can be clicked to add referral input data and other information entered into the referral input data area 325 to a contacts list for that referral service provider. The contacts list can be stored in the database 120. In some implementations, the rolodex button 340 provides the referring service provider with access to candidate referral recipient service providers in a personal contacts listing of the referring service provider.

The referral display 300 can also include at least one recipient service provider interface 345 where the referring service provider or delegate can type a service providers name, identity number, office, or other information to identify a candidate recipient service provider, for example from a universal listing of service providers stored in the database 120 or from a private contact list of service providers stored in the database 120 or locally stored by the referring computing device 125.

In some implementations, the referral display 300 includes at least one home button 350, at least one dashboard button 355, at least one physicians (or other service provider) button 360, and at least one customized referral network button 365. In some implementations, the home button when clicked returns the referring service provider to the home page display 200. The dashboard button 355 when clicked provides (e.g., via a new web page, popup window or display) data regarding the referral service provider's account with the referral network, such as a history of activity by the referral service provider on the referral network. In some implementations, the service provider button 360 is clicked to open a drop down menu identifying one or more service providers. The customized referral network button 365 can include administrative information about one or more referral network accounts, such as the name or logon identifier of the account holder, the type of account (e.g., a basic free account or a paid subscription account).

The referral display 300 can also include at least one referral service provider recipient area 370, such as the blank area in the example of FIG. 3 and FIG. 3A that can be populated, for example in a text box, or window with names or identifying information of at least one service provider that is a candidate to receive the referral. In some implementations, a first rendering of the referral web page obtains referral input data or other input information via input interfaces of the referral data input area 325, and a second rendering of the referral display 300 displays candidate service providers to receive the referral in the service provider recipient area 370. For example, the referral network engine 115 can process the referral input data or the remittance data, and the data processing system 110 can provide the referral display 300 for display at the referring computing device 125 with service provider data that satisfying the input information.

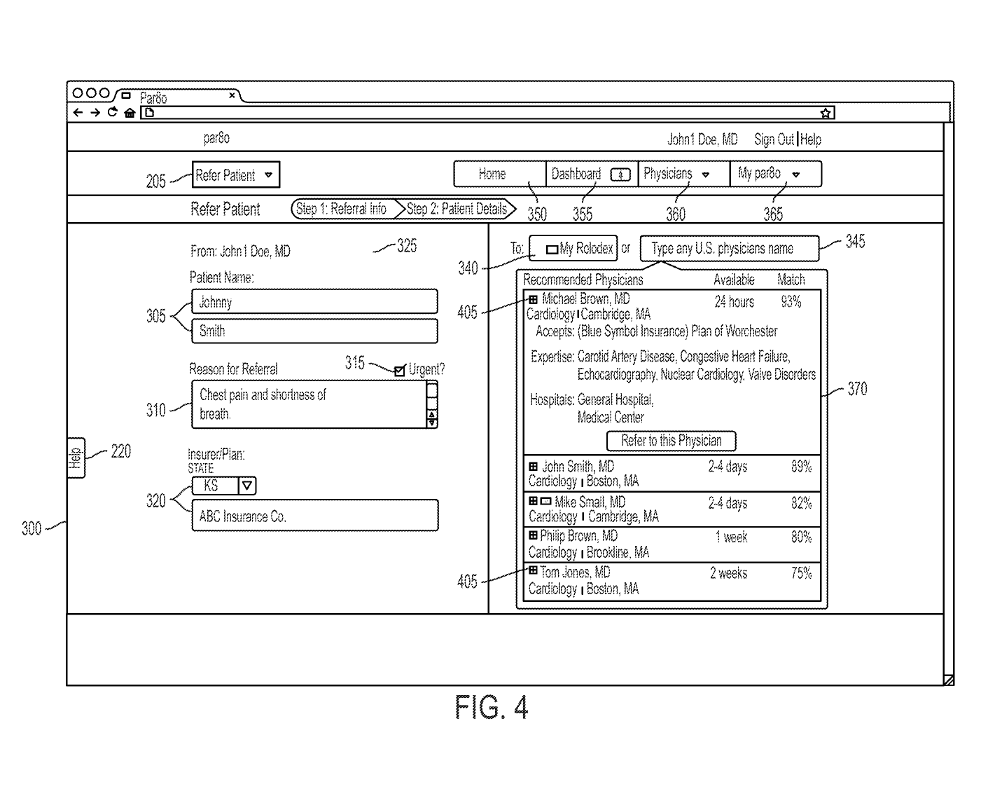

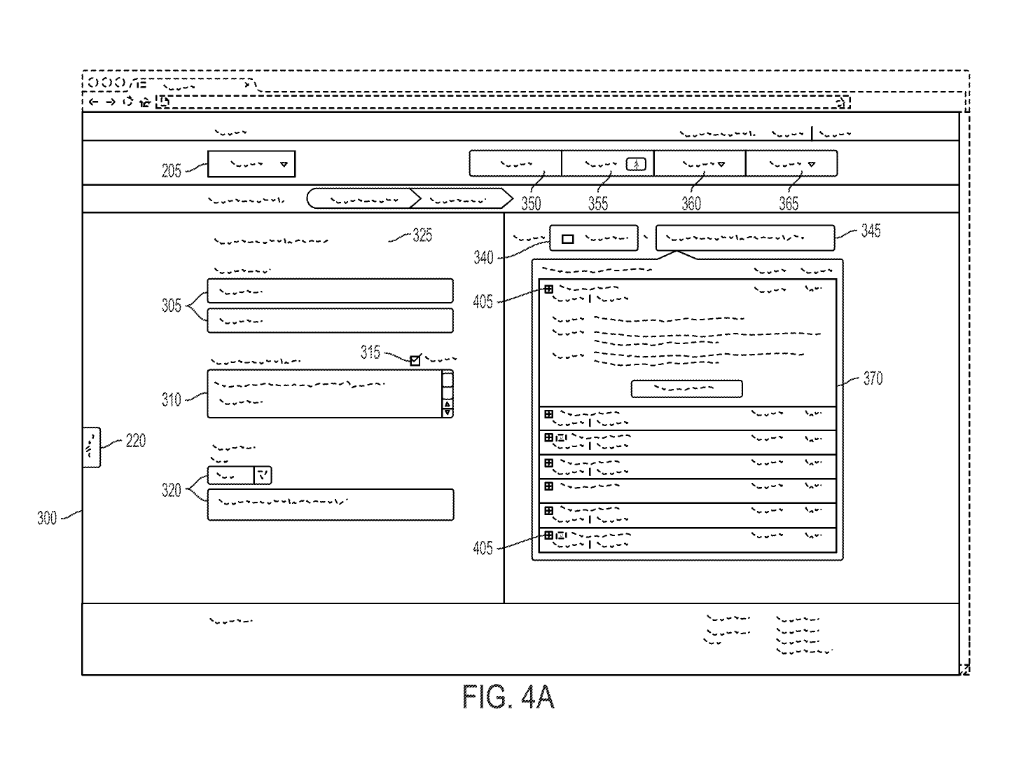

FIG. 4 and FIG. 4A depict an example of the referral display 300 of the referral network with the referral data input area 325 populated with input information and the recipient area 370 populated with service provider data. Responsive to referring service provider input, the name interface 305 can display the name of the patient or other subject seeking a referral, e.g., “Johnny Smith” in this example. The subject condition interface 310 can indicate “chest pain and shortness of breath” or other subject condition data, and the remittance data interface 320 can indicate that the subject has health insurance coverage from “ABC Insurance Co.” in the U.S. state of Kansas.

This input data can be obtained by the data processing system 110 and the referral network engine 115 can evaluate this input data to identify candidate referral recipient service providers for display in the referral recipient area 370, such as a listing of recommended physicians as in the example of FIG. 4 and FIG. 4A. The input data as well as data indicating the candidate service providers can be stored in the database 120 and accessed by the data processing system for display at the referring computing device 125 or the recipient computing device 130 with the referral display 300.

The data processing system 110 can rank or order the listing of service providers displayed in the referral recipient area 370. For example, the most prominently displayed service provider in the listing (e.g., the first, highest, or largest data display) can be the service providers having the largest number of offered or accepted past referrals, or the most offered or accepted past referrals from the referring service provider. The service providers in the referral recipient area 370 can also be ordered for display by the data processing system 110 based on geographic proximity between the recipient service provider and the subject or the referral service provider, membership in a referral network, or based on remittance data (e.g., an insurance plan) accepted by the recipient service provider.

In some implementations, the data processing system 110 orders the display of service providers in the referral recipient area 370 based at least in part on referral input data such as subject condition data obtained via the subject condition interface 310 or remittance data obtained via the remittance interface 320. For example, the referral network engine 115 can search the database for service providers having a specialty (e.g., cardiologists) matching a reason for referral indicated in the subject condition interface 310 (e.g., chest pain). In this example, cardiologists may be listed higher than other service providers within the referral recipient area. In another example, service providers accepting insurance from the insurance company indicated in the remittance interface 320 (e.g., ABC Insurance Co.) can receive a higher listing than out of network service providers.

In some implementations, a link, box or button 405 (e.g., proximate to the service providers indicated in the referral recipient area 370) can be clicked to instruct the data processing system 110 to provide an expanded display of data for the corresponding service provider. For example, the button 405 can be clicked once to display additional data such as accepted remittance data, areas of specialization or expertise, location, or employer (e.g., a hospital). The button 405 can also be clicked to retract additional data about a service provider, for example to revert back to an initial display.

The service provider data displayed in the referral recipient area 370 (in standard or expanded form) can indicate an availability period during which the service provider generally is available to offer services to the subject seeking the referral. For example, the availability data can include time periods of 24 hours, eight hours, one data, one week, one month, or time periods of two to four days, two weeks, or three weeks. For example, availability data indicating a time period of two to four days generally indicates that the corresponding service provider is willing to schedule an appointment to see or provide services to the subject during a time period of two to four days from receipt of a referral request, or from acceptance of the referral request.

In some implementations, the availability data does not require service provider availability to schedule an appointment during 100% of the availability time period. For example, a service provider with an availability time period of two weeks may be available to schedule appointments during some working hours of that two week period, e.g., between portions of the day between 9:00 AM and 5:00 PM where the service provider is not otherwise occupied. In some implementations, the availability time period is not an appointment or an appointment time period. Rather, in some implementations appointments can be made during a sub-period (e.g., one hour) of the availability time period (e.g., one week).

The service provider data displayed in the referral recipient area 370 (in standard or expanded form) can also indicate a degree or percentage of the match between service provider data and referral input data. For example, the referral network engine 115 can determine that a service provider accepting an insurance plan indicated by the remittance data and having a specialty in treating the reason for referral (e.g., the subject condition data) has a higher percentage match than a service provider accepting the same insurance plan but lacking or having a less closely related specialty to the reason for referral. In some implementations, the service providers can indicate preferred referral input data, such as a preferred insurance carrier. These service providers can receive a higher match percentage from the referral network engine 115 when referral input data of a subject includes remittance data having the preferred insurance carrier. The subject or referring service provider can also indicate preferences (e.g., specialized expertise, insurance plans, or availability data) that can be reflected in the match percentages (e.g., higher or lower) of the recipient service providers and in their order of display in the referral recipient area 370.

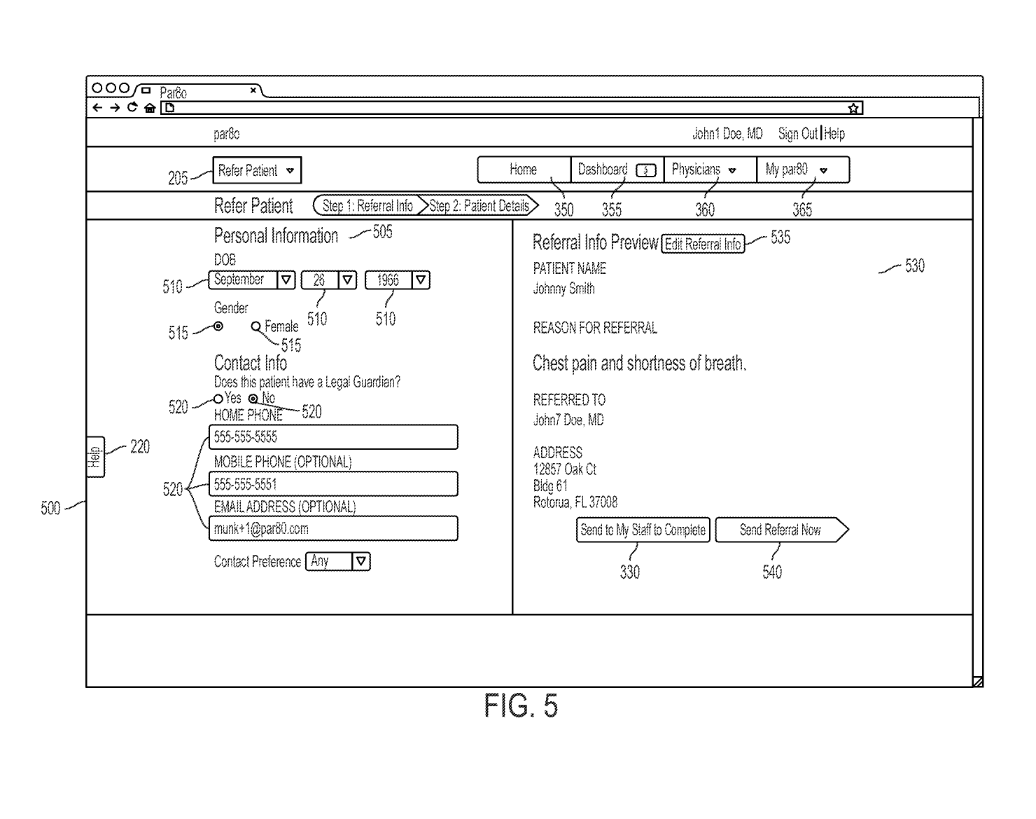

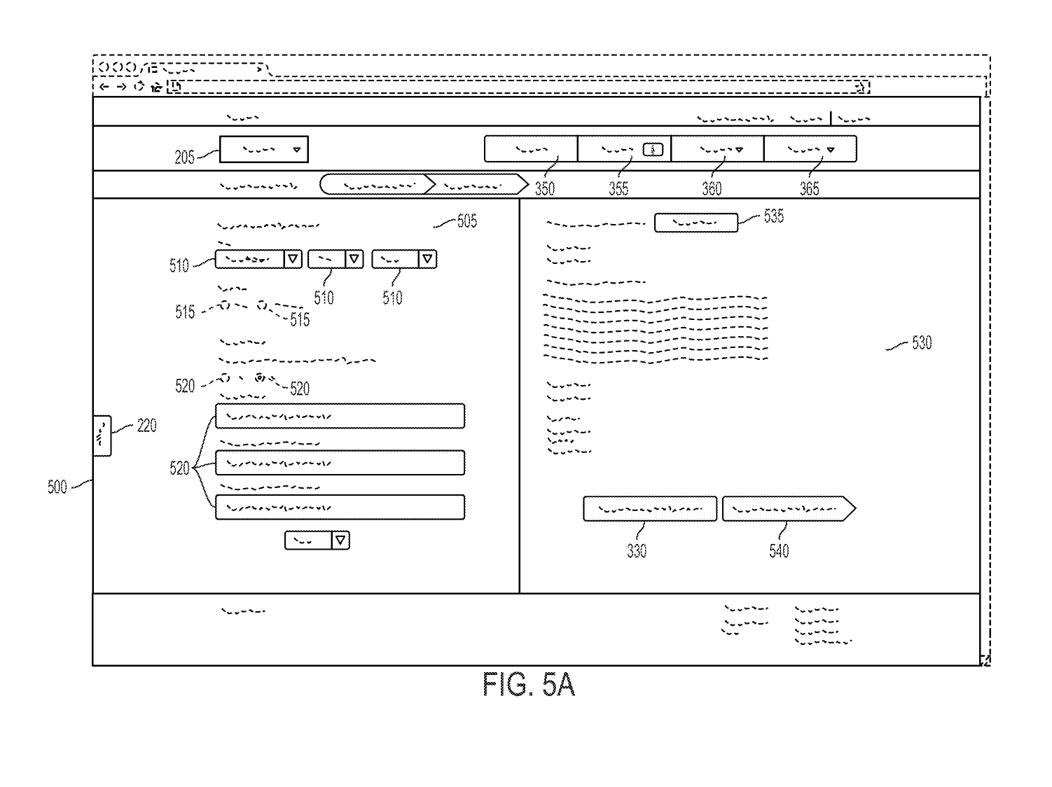

FIG. 5 and FIG. 5A depict an example environment for obtaining referral data via a referral preview display 500 according to an illustrative implementation. The referral preview display 500 can include a web page, pop-up window, or other online document or information resource, and can include at least one personal information area 505. In one implementation, the data processing system 110 can provide the referral preview display 500 for display at the referring computing device 125, for example responsive to actuation of the patient details button 335 of the referral display 300 or responsive to a referring service provider logging onto the referral network.

The personal information area 505 can include a uniform or monochromatic background with a plurality of interfaces (e.g., text boxes or buttons) to receive or display personal information about a subject, such as referral input data. For example, the personal information area 505 can include at least one date of birth interface 510 that can be clicked to open a drop down menu for the selection of the day, year, or month of a subject's birth. The personal information area 505 can also include at least one gender interface 515 to indicate the subject's gender, and at least one contact interface 520 to indicate contact information such as the subject's home or mobile telephone number, address, or email address for example. In one implementation, the contact interface indicates that the subject is a minor, or does or does not have a parent or legal guardian. The personal information area 505 may also include at least one contact preference interface 525 to indicate a manner in which the subject prefers to be contacted, (e.g., phone or email).

In some implementations, the personal information area 505 consists of at least one interface to obtain or display personal information of the subject, e.g., the date of birth interface 510, the gender interface 515, the contact interface 520, or the contact preference interface 525. In this example, the personal information area 505 can be void of additional interfaces and displays of subject data. In various implementations, the personal information area 505 can consist of one, two, three, or more personal information interfaces such as any one or more of the date of birth interface 510, the gender interface 515, the contact interface 520, or the contact preference interface 525. The personal information area 505 can be defined by a uniform or monochromatic background color or marked boundary, with interfaces 510, 515, 520, or 525 disposed within the personal information area 505. In this example, the interfaces 510, 515, 520, or 525 can include colors different than the background color of the personal information area 505. In some implementations, the personal information area 505 is an area occupying substantially (e.g., +/−10%) the half of the referral preview display 500, such as the left vertical half of the referral preview display 500.

The referral preview display 500 can also include at least one referral preview area 530. The data processing system 100 can display the referral preview area 530 with the referral preview display 500 at the recipient computing device 130. The referral preview area 530 can display the request for referral prior to submitting it to a recipient service provider at the recipient computing device 130. For example, the referral preview area 530 can include the name of the patient (or other subject), as well as reasons for making the referral, e.g., subject condition data. The referral preview area 530 can also indicate the name, address, or other information about the recipient service provider such as the type of service or specialty (e.g., cardiology) offered by the recipient service provider.

The referral preview area 530 can include at least one edit referral info button (or other interface such as a link or text box) 535. For example, the edit referral info button 535 can be clicked at the referring computing device 125 to cause the data processing system 110 to provide the referral display 300 for display at the referring computing device 125, where the referring service provider or delegate thereof can enter referral input data.

The referral preview area 530 can also include at least one send referral button 540. In some implementations, the referring service provider clicks the send referral button 540. Responsive to this input, the referring computing device 125 or the data processing system 110 sends the referral request via the network 105 for display at the recipient computing device 130 to the recipient service provider.

In some implementations, the data processing system 110 determines whether or not the recipient service provider is a member of the referral network. For example, the data processing system 110 can determine that the recipient service provider has an account or personalized page with the referral network and is a member of the referral network. The data processing system 110 can also determine that the recipient service provider has a subscription with the referral network (paid or free) and is thus a member of the referral network. Information identifying members of the referral network can be stored in the database 120 and accessed by the data processing system 110.

In one implementation, the data processing system 110 identifies the recipient service provider as a member of the referral network and provides the referral request for display at the recipient computing device 130 via the referral network. For example, an email, text message, or other communication can be sent to a contact address of the recipient service provider to alert the recipient service provider to a referral via the referral network. The email may instruct the recipient service provider to logon to the referral network to receive the referral request. The recipient service provider may logon to the referral network from the recipient computing device 130, view the referral request, and accept the referral request by sending an acceptance communication to the data processing system 110 or to the referring computing device 125 via the network 105. For example, the recipient service provider can click the referral management button 210 to access received referral requests and enter data into a resulting display interface indicating an acceptance of the referral request.

In some implementations, the data processing system 110 determines that the recipient service provider is not a member of the referral network. For example, the database 120 can include information about the recipient service provider (e.g., name, location, or type of service offered) but no data indicating that the recipient service provider has an account with the referral network. In one implementation, the data processing system 110 determines that the recipient service provider is not a member of the referral network, and sends a facsimile or email communication to the recipient service provider. This communication can instruct the recipient service provider to join the referral network in order to view all or part of the referral request, or to accept the referral. This communication (e.g., a facsimile transmission) can include at least some of the referral input data of the referral request such as subject condition data or remittance data.

In one implementation, the name or medical records are absent from the facsimile (or other) communications indicating the existence of a referral request sent to recipient service providers who are not members of the referral network. In some implementations, the referring service provider clicks the send referral button 540 to cause the data processing system 110 or the referring computing device 125 to send the facsimile transmission to the recipient service provider via the network 105. In another implementation, the referring service provider clicks the send referral button 540 and receives instructions displayed at the referring computing device to send a facsimile (or other form of communication) indicating the existence of a referral request separately to the recipient service provider. When a referral request is accepted, the subject and the recipient service provider can communicate via the referral network, the network 105 or in another fashion to schedule an appointment.

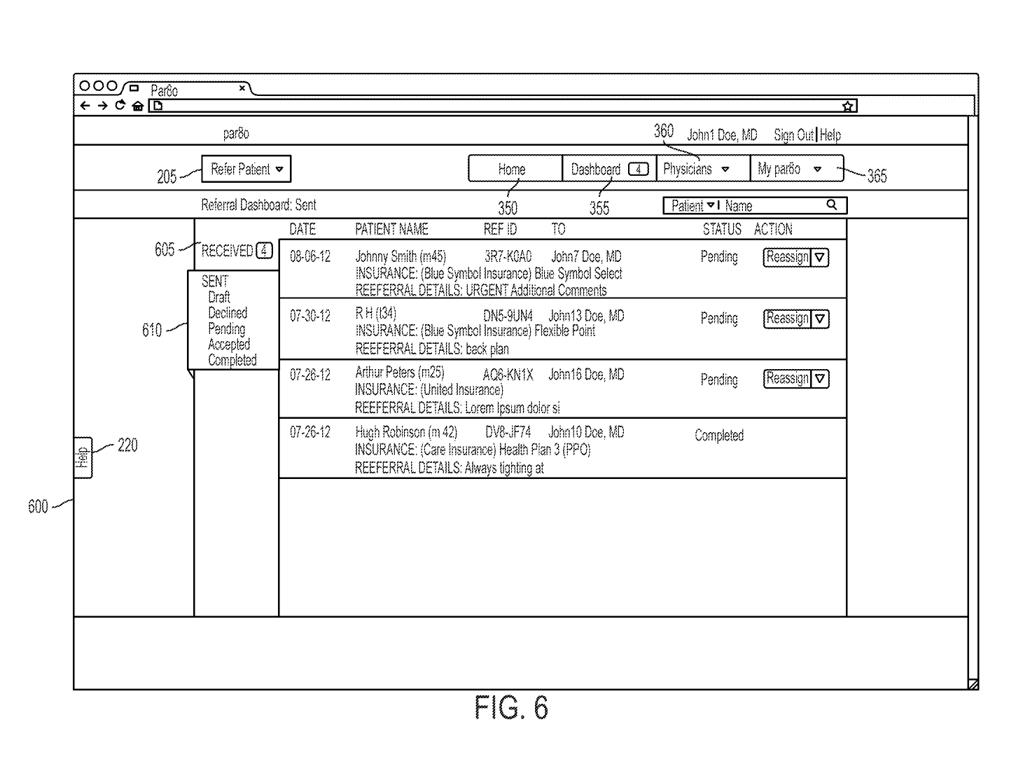

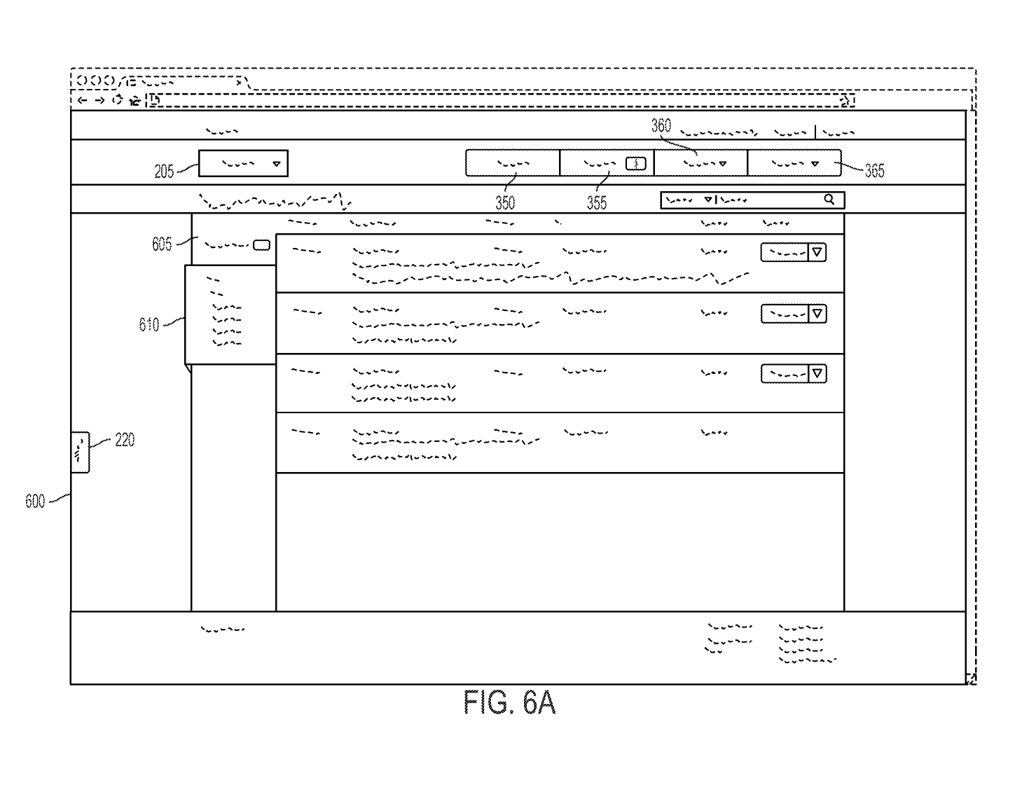

FIG. 6 and FIG. 6A depict an example environment for managing referrals via at least one dashboard display 600 according to an illustrative implementation. The dashboard display 600 can include a web page, pop up window or other document provided by the data processing system 110 (e.g., via the database 120) for display at the referring computing device 125 or the recipient computing device 130. In some implementations, the dashboard display 600 is provided responsive to actuation (e.g., clicking) of the referral management button 210 or the dashboard button 355. The dashboard display 600 can display received referrals (e.g. to the recipient service provider at the recipient computing device 130) or sent referrals (e.g., to the referring service provider at the referring computing device 125). In some implementations, the service provider accesses the dashboard display subsequent to logging onto the referral network, e.g., by providing username or password information to the data processing system 110 via the network 105.

In some implementations, the dashboard display 600 displays referrals including referral input data or other information about the subject, such as the subject condition data (e.g., reasons for the referral), the remittance data, or the subject's name or other administrative information about the subject. The dashboard display 600 can display received or sent referrals in a sorted manner. In some implementations, the service provider can select a link (e.g., a received link 605 or a sent link 610) to sort the referrals by sent or received status. The dashboard display 610 can also include at least one supplemental link that can be selected to sort referrals by status, such as pending referrals, accepted referrals, declined referrals, completed referrals, incomplete referrals, archived referrals, or draft referrals.

Referral data displayed by the dashboard display 600 can include the subject's name, remittance data, subject condition data, the referring service provider, the recipient service provider, a reference identifier corresponding to a referral request, or a status of the referral request (e.g., pending, accepted, completed, declined, or draft). In one implementation, the dashboard display 600 includes a sorting interface 615 for data entry to sort referrals by subject name, for example.

In some implementations, the home page display 200, the referral display 300, the referral preview display 500 and the dashboard display 600 are displays such as web pages, popup windows, online documents, or other information resources of a referral network administered by the data processing system 110. The referral network can include additional displays of data to manage, create, modify, transmit, accept, decline, or process referrals between service providers. In some implementations, service providers can join the referral network as members, and the referral network can include data (e.g., in the database 120) about service providers who are or are not members of the referral network.

In some implementations, the referral network, referral requests, and other communications between referring computing devices 125, the data processing system 110, and the recipient computing device 130 comply with the Health Insurance Portability and Accountability Act or the Patient Safety and Quality Improvement Act (HIPAA) by protecting the privacy of individually identifiable health information. In one implementation, the referral network, referral requests, and other communications between referring computing devices 125, the data processing system 110, and the recipient computing device 130 comply with the Administrative Simplification (AS) provisions of Title II of HIPAA. Communications via the network 105 can be encrypted.

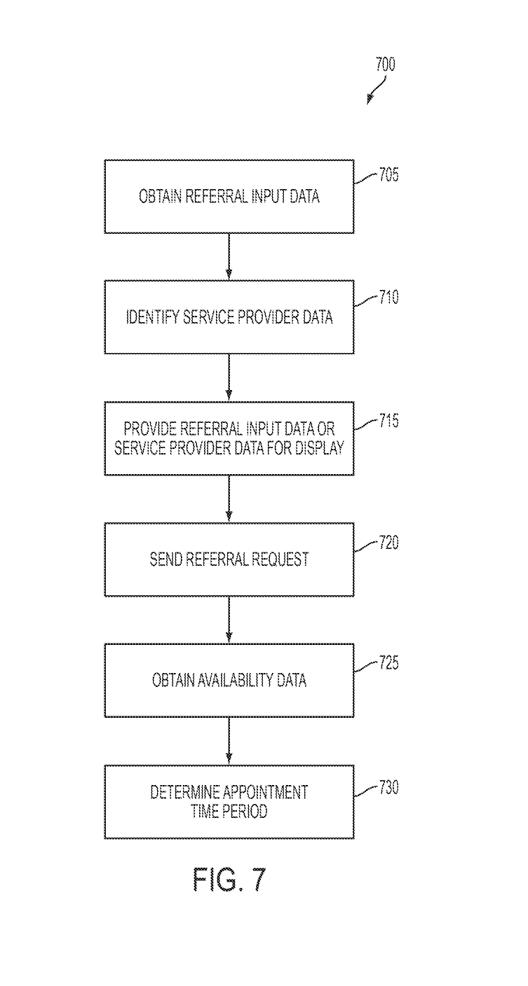

FIG. 7 depicts a flow chart for a method 700 of providing information via a communications network, according to an illustrative implementation. The method includes an act of obtaining referral input data (ACT 705). For example, an online referral network administered by a data processing system can provide a web page or other display to a referring computing device where a referring service provider or their delegate can inter referral input data into an interface of the display. The obtained referral input data can include remittance data, subject identifying data, or subject condition data, for example, and can be stored in a database associated with the referral network. In one implementation, the referral input data is obtained (ACT 705) from a referring service provider that is a member of the referral network. The referral input data can be obtained (ACT 705) from a service provider such as a health care provider) or a delegate of the service provider, such as the health care providers secretary.

In some implementations, to obtain referral input data (ACT 705) the data processing system administering the referral network can provide a home page display (e.g., a web page) for display on a referring computing device. The home page display (or other document display) can include a web page or other information resource that may have interfaces such as text boxes, drop down menus, links, drag and drop interfaces, touch screens, or voice activated interfaces to obtain the referral input data (ACT 705).

The method 700 can also identify service provider data (ACT 710). For example, the data processing system of the referral network can evaluate the obtained referral input data (ACT 705) and identify matching service providers from data stored in a database. The matching service providers generally offer services that satisfy at least some of the referral input data, such as service providers who accept insurance indicated in the remittance data, or service providers who offer a service that satisfies criteria indicated in the subject condition data or other reasons for referral. Other factors, such as geographic location, availability, and cost to the subject seeking the referral can also be evaluated by the data processing system to identify service provider data associated with a service provider (ACT 710).

In some implementations, the obtained service provider data (ACT 710) includes an indication of preferred criteria, such remittance or subject condition data preferred by the service provider. For example, a service provider can indicate a preference of a certain insurance policy (e.g., preferred remittance data) or a preferred subject condition (e.g., subjects with a particular medical condition).

The method 700 can also provide referral input data or service provider data for display (ACT 715). For example the data processing system can provide a web page or other document of the referral network for display (ACT 715) at a referring computing device or a recipient computing device. The display can include referral input data such as subject condition data, remittance data, or other subject information for display. The display can also include service provider data about one or more service providers that are candidates to receive a request for a referral, such as name, address, location, or remittance data, or the type of service offered, or statistical data such as the number of past referrals the service provider has received, accepted, or declined. The service provider data can also indicate that the service provider is or is not a member of the referral network.

In some implementations, to provide referral input data or service provider data for display (ACT 715) the data processing system administering the referral network can provide a referral display, review preview display, or dashboard display for display on a referring computing device (e.g., to a referring service provider) or a recipient computing device (e.g., to a recipient service provider. These displays, (e.g., web pages or other information resources) can include interfaces such as text boxes, drop down menus, links, drag and drop interfaces, touch screens, or voice activated interfaces to display the referral input data or the service provider data (ACT 715).

In some implementations, the service provider data is provided for display within the referral network (ACT 715) with data identifying a plurality of service providers in a ranked order. The ordering can be based, for example, on a degree of a match between referral input data and service provider data, the geographic location of the subject, the referring service provider, or the recipient service providers, membership of the recipient service providers in the referral network, a type of membership of the recipient service providers with the referral network (e.g., basic, premier, free, or paid subscription), a number of past referrals received or accepted by the recipient service providers, or availability data of the recipient service providers, for example.

The method 700 can also send the referral request (ACT 720). In some implementations, the data processing system sends, or provides instructions to send, a referral request to a recipient computing device (e.g., a computer or facsimile machine) associated with the service provider that is the recipient of the referral request. The referral request can be sent (ACT 720) via a communications network, and can include at least a portion of the referral input data. In one implementation, the data processing system of the referral network determines that a service provider is a member of the referral network, and sends the referral request to the service provider (ACT 720) via the referral network.

In some implementations, the data processing system of the referral network determines that a service provider is not a member of the referral network, and sends the referral request to the service provider (ACT 720) via a facsimile transmission. For example, the data processing system may transmit, or provide instructions to transmit a referral request to a service provider via facsimile transmission with the name of the subject being absent from the facsimile transmission. In some implementations, the referral request is sent (ACT 720) to a service provider with medical records of the subject withheld from the referral request. In one implementation, the referral request is sent (ACT 720) via the referral network and displayed on an information resource (e.g., web page) of the referral network at a recipient computing device associated with the recipient service provider.

The method 700 can obtain availability data from the recipient service provider (ACT 725). For example, the recipient service provider can join or logon to the referral network to accept the referral request and provide data indicating the service provider's availability. The obtained availability data (ACT 725) can be based on the referral input data. For example, a recipient service provider can indicate longer (e.g., two weeks) or shorter (e.g., one week) availability time periods based on the subject condition data or the remittance data. The availability data can be displayed on a web page (or other information resource) of the referral network, for example together with service provider data that identifies the recipient service provider.

Availability data can be based on preferred referral input data as well. For example, the obtained availability data (ACT 725) can time shift, (e.g., expedite or delay) an availability time period based on a recipient service provider's indication of preferred subject condition or remittance data. In this example, the referral network can receive from a service provider an indication that the service is available to see subjects having one type of insurance in one to three days, and available to see subjects having another type of insurance within two to three weeks. In another example, the service provider can indicate availability to see subjects having a specified medical condition within 24 hours, and all other subjects within one week. These are examples, and the service provider can provide different availability data for different conditions, e.g., subject condition, remittance data, day of the week, cost of a service, or geographic location, for example. In some implementations, the method 700 can determine an appointment time period (ACT 730). The appointment time period can be a time period (e.g., one hour or 30 minutes) within the availability time period (e.g., within two weeks from acceptance of a request for a referral).

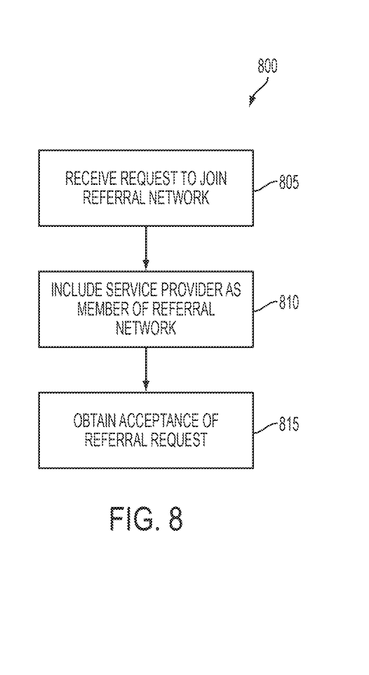

FIG. 8 is a flow chart depicting a method 800 of providing information via a communications network. The method 800 can receive a request to join a referral network (ACT 805). For example, the data processing system administering the referral network can receive a request from a service provider to join the referral network (ACT 805). In some implementations, the service provider receives a referral request, for example via facsimile transmission. This referral request can instruct the recipient service provider to logon to the referral network to accept the referral request. A service provider that is not a member of the referral network can access a web page of the referral network to join the network, for example by providing administrative data about the service provider such as name, address, type of services offered by the service provider, subject conditions that the service provider is able to treat, or insurance or other remittance data the service provider accepts for services rendered for example. In one implementation, the referral network receives a request to join a referral network (ACT 805) responsive to an act of sending a referral request to the service provider (ACT 720).

The method 800 can include service providers as members of the referral network (ACT 810). For example, the data processing system operating the referral network can obtain username, password, and service provider data from the service provider to create an account for the service provider, which can be stored in a database associated with the referral network. In one implementation, the service provider is included as a member of the referral network (ACT 810) responsive to a request to join the referral network received from the service provider (ACT 805). In some implementations, the service provider joins without receiving referral request. For example, one service provider can invite another to join the referral network, or a service provider can discover and request to join the referral network of his or her own initiative.

The method 800 can also obtain an acceptance of the referral request (ACT 815). In some implementations, the service provider is included as a member of the referral network (ACT 810) before the service provider can accept the referral request. In this example, the referral network, (or the referring service provider or subject) obtains acceptance of the referral request after the recipient service provider joins the referral network. In some implementations, subsequent the obtaining acceptance of the referral request (ACT 815) the recipient service provider and the subject schedule an appointment for the service provider to provide a service, such as a medical examination, to the subject.

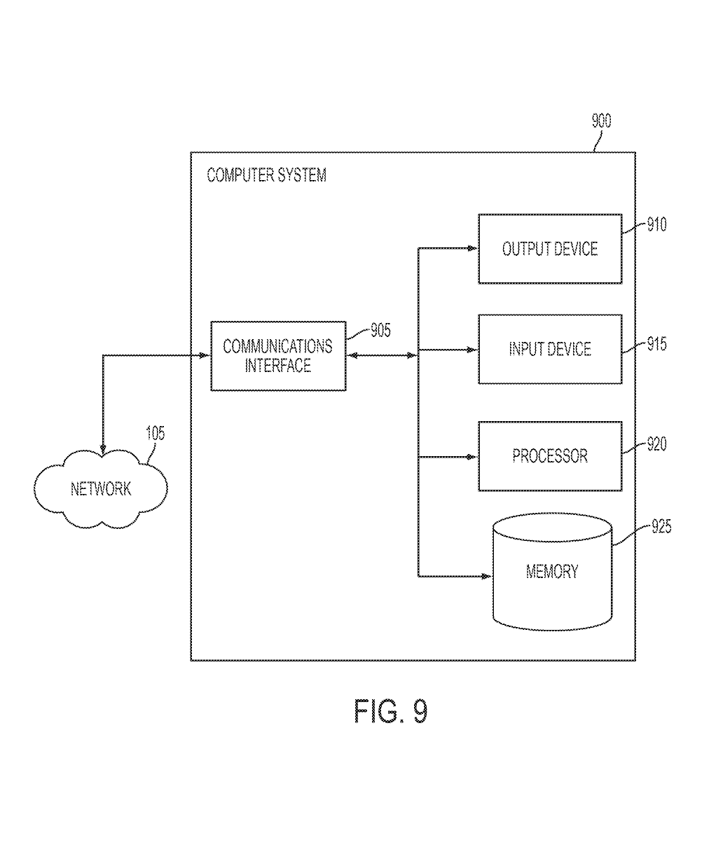

FIG. 9 shows the general architecture of an illustrative computer system 900 that may be employed to implement any of the computer systems discussed herein (including the system 100 and its components such as the referral network engine 115) in accordance with some implementations. The computer system 900 can be used to provide information via a communications network such as the network 105. The computer system 900 of FIG. 9 comprises one or more processors 920 communicatively coupled to memory 925, one or more communications interfaces 905, and one or more output devices 910 (e.g., one or more display units) and one or more input devices 915. The processors 920 can be included in the data processing system 110 or the other components of the system 100 such as the referral network engine 115.

In the computer system 900 of FIG. 9, the memory 925 may comprise any computer-readable storage media, and may store computer instructions such as processor-executable instructions for implementing the various functionalities described herein for respective systems, as well as any data relating thereto, generated thereby, or received via the communications interface(s) or input device(s) (if present). Referring again to the system 100 of FIG. 1, any of the data processing system 110, the referral network engine 115, and the database 120 can include the memory 925 to store referral input data, service provider data, and other referral network information such as referral network membership information. The processor(s) 920 shown in FIG. 9 may be used to execute instructions stored in the memory 925 and, in so doing, also may read from or write to the memory various information processed and or generated pursuant to execution of the instructions.

The processor 920 of the computer system 900 shown in FIG. 9 also may be communicatively coupled to or control the communications interface(s) 905 to transmit or receive various information pursuant to execution of instructions. For example, the communications interface(s) 905 may be coupled to a wired or wireless network, bus, or other communication means and may therefore allow the computer system 900 to transmit information to and/or receive information from other devices (e.g., other computer systems). While not shown explicitly in the system of FIG. 1, one or more communications interfaces facilitate information flow between the components of the system 100. In some implementations, the communications interface(s) may be configured (e.g., via various hardware components or software components) to provide a website as an access portal to at least some aspects of the computer system 900. Examples of communications interfaces 905 include user interfaces (e.g., web pages) for referral input data or service provider data, such as availability data determined by the referral network engine 115 and provided for display at the computing device 125 or the recipient computing device 130.

The output devices 910 of the computer system 900 shown in FIG. 9 may be provided, for example, to allow various information to be viewed or otherwise perceived in connection with execution of the instructions. The input device(s) 915 may be provided, for example, to allow a user to make manual adjustments, make selections, enter data or various other information, or interact in any of a variety of manners with the processor during execution of the instructions. Additional information relating to a general computer system architecture that may be employed for various systems discussed herein is provided at the conclusion of this disclosure.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. The program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The features disclosed herein may be implemented on a desktop, laptop, or other personal computer, a personal digital assistant, a smartphone, a tablet computing device, other mobile phone, handheld computer, or other computing device. The operations described in this specification can be implemented as operations performed by a data processing apparatus on data stored on one or more computer-readable storage devices or received from other sources.

The term computing device encompasses apparatuses, devices, or machines for processing data, such as a programmable processor, a computer, a system on a chip, or combinations thereof. The computing device 125 and the recipient computing device 130 can include special purpose logic circuitry, e.g., an FPGA (field programmable gate array) or an ASIC (application-specific integrated circuit). These devices can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. The data processing system 110, including the referral network engine 115 and the database 120 can include or share one or more data processing apparatuses, computing devices, or processors.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application-specific integrated circuit).

Processors suitable for the execution of a computer program may include general or special purpose microprocessors, or one or more processors of a digital computer. The processor can receive instructions and data from a read-only memory or a random access memory. The computing device can include a processor for performing actions in accordance with instructions and one or more memory devices for storing instructions and data. The computing device can also include, or be operatively coupled to receive data from or transfer data to, or both, one or more mass storage devices for storing data, e.g., magnetic, magneto-optical disks, or optical disks. However, the computer need not have such devices. The computing device can be embedded in another device, e.g., a mobile telephone, tablet computer, a personal digital assistant (PDA), a mobile audio or video player, a game console, a Global Positioning System (GPS) receiver, or a portable storage device (e.g., a universal serial bus (USB) flash drive), for example. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this discloser can be implemented on a computing device having a display device, e.g., a CRT (cathode ray tube), plasma, or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as system 900 or system 100 can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular implementations of the systems and methods described herein. Certain features that are described in this specification in the context of separate implementations can also be implemented in combination in a single embodiment or implementation. Conversely, various features that are described in the context of a single implementation can also be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

In certain circumstances, multitasking and parallel processing may be implemented. Moreover, the separation of various system components in the implementations described above should not be understood as requiring such separation in all implementations, and it should be understood that the described program components and systems can generally be integrated together in a single software product or packaged into multiple software products. For example, the data processing system 110 and the referral network engine 115 can be a single module or engine, or a logic device having one or more processing circuits.

Having now described some illustrative implementations and implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed only in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementation,” “an alternate implementation,” “various implementation,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. For example, buttons such as the refer patient button 205, the referral management button 210, or the rolodex management button 215 can include or be links, roll over areas, inputs, data entry points or other interfaces or inputs. Further, the referral network and system is applicable to environments other than health care environments. The data processing system can generate, provide, and obtain responses to referral requests and other information via a communications network involving service providers in non medical services such as psychiatric services, or in other industries, such as sales, restaurants, merchants, or event or transportation tickets, for example. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A computer implemented method of providing information via a communications network, comprising:
obtaining, by a data processing system, referral input data, wherein the referral input data includes at least one of subject condition data and remittance data;
identifying, from a database, service provider data associated with a service provider, based on the referral input data;
providing at least one of the referral input data and the service provider data for display by a referring computing device associated with the data processing system;
sending a referral request via the communications network to a recipient computing device associated with the service provider, the referral request including at least a portion of the referral input data;
obtaining, responsive to the referral request, availability data of the service provider based on at least one of the subject condition data and the remittance data, the availability data indicating a first time range that is not a defined appointment time period, wherein the service provider is unavailable for at least a portion of the first time range; and
obtaining, from the recipient computing device associated with the service provider, an indication to time shift the availability data, wherein the availability data indicates the first time range that is not the defined appointment time period, and wherein the time shift moves the availability data indicating the first time range to availability data indicating a second time range, based on at least one of the subject condition data and the remittance data.

2. The computer implemented method of claim 1, further comprising:
obtaining an indication from the service provider of preferred remittance data; and
determining that the referral input data includes the preferred remittance data.

3. The computer implemented method of claim 1, wherein the remittance data includes insurance data, further comprising:
obtaining the indication to time shift the availability data indicating the first time range based on the insurance data.

4. The computer implemented method of claim 1, further comprising:
obtaining the indication to time shift the availability data indicating the first time range based on the subject condition data.

5. The computer implemented method of claim 1, further comprising:
time shifting the availability data indicating the first time range based on a cost of services offered by the service provider.

6. The computer implemented method of claim 1, wherein the time range is at least eight hours, and
wherein the appointment time period is within the time range and less than eight hours.

7. The computer implemented method of claim 1, wherein the service provider is a first service provider, further comprising:
identifying a plurality of service providers including the first service provider; and
ordering the plurality of service providers for display by the referring computing device based on at least one of the referral input data, geographic location data, membership in a referral network, and availability data of at least one of the plurality of service providers.

8. The computer implemented method of claim 7, further comprising:
providing data corresponding to the plurality of service providers for display by the referring computing device.

9. The computer implemented method of claim 7, further comprising:
identifying a second service provider, wherein the second service provider is absent from the plurality of service providers; and
providing data corresponding to the second service provider for display by the referring computing device.

10. The computer implemented method of claim 7, wherein the plurality of service providers are members of a referral network.

11. The computer implemented method of claim 1, further comprising:
determining that the service provider is a member of a referral network; and
providing the referral request to the recipient computing device via the referral network.

12. The computer implemented method of claim 1, further comprising:
determining that the service provider is not a member of a referral network; and
providing the referral request to the recipient computing device via a facsimile transmission.

13. The computer implemented method of claim 12, wherein the referral input data includes a name of a subject, further comprising:
providing the referral request to the recipient computing device via the facsimile transmission, wherein the name of the subject is absent from the facsimile transmission.

14. The computer implemented method of claim 1, further comprising:
receiving a request for the service provider to join a referral network associated with the referral input data;
including the service provider as a member of the referral network; and
subsequent to including the service provider as the member of the referral network, obtaining an acceptance of the referral request from the service provider.

15. The computer implemented method of claim 1, further comprising:
obtaining the referral input data from one of a health care provider and a delegate of the health care provider.

16. The computer implemented method of claim 15, wherein one of the health care provider and the delegate of the health care provider are members of a referral network, further comprising:
identifying the service provider as not being a member of the referral network.

17. The computer implemented method of claim 1, wherein the referral input data includes referral input data of a subject, further comprising:
sending the referral request to the recipient computing device, wherein a medical record of the subject is absent from the referral request.

18. The computer implemented method of claim 1, wherein the referral input data includes geographic location data of a subject, further comprising:
obtaining geographic location data of the service provider.

19. The computer implemented method of claim 1, wherein:
the first time range is based on a first condition and the second time range is based on a second condition.

20. The computer implemented method of claim 1, further comprising:
providing a home web page of a referral network for display on at least one of the referring computing device and the recipient computing device, the home web page including a button display area and a help tab,
further consisting of the button display area consisting of three operational interfaces.

21. The computer implemented method of claim 1, further comprising:
providing a referral web page for display on at least one of the referring computing device and the recipient computing device, the referral web page including a referral input data area and a service provider recipient area,
further consisting of the referral input data area consisting of at least two name interfaces, one subject condition interface, and at least one remittance data interface.

22. A system of providing information via a communications network, comprising:
a data processing system having at least one server including at least one of a referral network engine and a database, the data processing system configured to:
obtain referral input data, wherein the referral input data includes at least one of subject condition data and remittance data;
identify, based on the referral input data, service provider data associated with a service provider;
provide at least one of the referral input data and the service provider data for display by a referring computing device associated with the data processing system;
send a referral request using the server via the communications network to a recipient computing device associated with the service provider, the referral request including at least a portion of the referral input data;
obtain, responsive to the referral request, availability data of the service provider based on at least one of the subject condition data and the remittance data, the availability data indicating a first time range that is not a defined appointment time period, wherein the service provider is unavailable for at least a portion of the first time range; and
obtain, from the recipient computing device associated with the service provider, an indication to time shift the availability data, wherein the availability data indicates the first time range that is not the defined appointment time period, and wherein the time shift moves the availability data indicating the first time range to availability data indicating a second time range, based on at least one of the subject condition data and the remittance data.

23. The system of claim 22, wherein the service provider is a first service provider, further comprising the data processing system configured to:
identify a plurality of service providers including the first service provider; and
rank the plurality of service providers for display by the referring computing device based on at least one of the referral input data, geographic location data, membership in a referral network, and availability data of at least one of the plurality of service providers.

24. The system of claim 22, further comprising the data processing system configured to:
obtain an indication from the service provider of preferred remittance data;
determine that the referral input data includes the preferred remittance data; and
determine the availability data based on the preferred remittance data.

25. The system of claim 22, wherein the remittance data includes insurance data, further comprising the data processing system configured to:
obtain the indication to time shift the availability data indicating the first time range based on the insurance data.

26. The system of claim 22, wherein the data processing system is further configured to:
determine that the service provider is a member of a referral network; and
provide the referral request to the recipient computing device via the referral network.

27. The system of claim 22, further comprising the data processing system configured to:
determine that the service provider is not a member of a referral network; and
provide the referral request to the recipient computing device via a facsimile transmission.

28. A non-transient computer readable medium having instructions to provide information on a communications network, the instructions comprising instructions to:
obtain referral input data, wherein the referral input data includes at least one of subject condition data and remittance data;
identify service provider data associated with a service provider based on the referral input data;
provide at least one of the referral input data and the service provider data for display by a referring computing device associated with the data processing system;
send a referral request using a server via a communications network to a recipient computing device associated with the service provider, the referral request including at least a portion of the referral input data;
obtain, responsive to the referral request, availability data of the service provider based on at least one of the subject condition data and the remittance data, the availability data indicating a first time range that is not a defined appointment time period, wherein the service provider is unavailable for at least a portion of the first time range; and
obtain, from the recipient computing device associated with the service provider, an indication to time shift the availability data, wherein the availability data indicates the first time range that is not the defined appointment time period, and wherein the time shift moves the availability data indicating the first time range to availability data indicating a second time range, based on at least one of the subject condition data and the remittance data.

29. The computer readable storage medium of claim 28, further comprising instructions to:
identify the indication to time shift the availability data indicating the first time range based on both the subject condition data and the remittance data.

30. The computer readable storage medium of claim 28, further comprising instructions to:
receive a request for the service provider to join a referral network associated with the referral input data;
include the service provider as a member of the referral network; and
obtain an acceptance of the referral request from the service provider.

31. The computer implemented method of claim 1, further comprising:
obtaining, by the data processing system, the indication to time shift the availability data via the database.
